(19) United States
(12) Patent Application Publication
(10) Pub. No.: US 2025/0033247 A1
(43) Pub. Date: Jan. 30, 2025

(54) CUTTING MONOCRYSTALLINE SILICON SQUARE ROD

(71) Applicant: TCL ZHONGHUAN RENEWABLE ENERGY TECHNOLOGY CO., LTD., Tianjin (CN)

(72) Inventors: Jianhua ZHANG, Tianjin (CN); Wei CUI, Tianjin (CN); Junwen GUO, Tianjin (CN); Tao LIU, Tianjin (CN); Bin GUO, Tianjin (CN); Zhimin ZHAO, Tianjin (CN)

(73) Assignee: TCL ZHONGHUAN RENEWABLE ENERGY TECHNOLOGY CO., LTD., Tianjin (CN)

(21) Appl. No.: 18/548,089

(22) PCT Filed: Jul. 31, 2023
(86) PCT No.: PCT/CN2023/110424

§ 371 Date: Aug. 27, 2023

(30) Foreign Application Priority Data
Oct. 19, 2022 (CN) 202211279194.4

(51) Int. Cl. B28D 5/04; B28D 5/00

(52) U.S. Cl. CPC B28D 5/042; B28D 5/0064; B28D 5/0082

(57) ABSTRACT

A method for cutting a monocrystalline silicon square rod may include the steps of: loading: providing a square rod on a working platform and clamping the square rod, and lowering the square rod until it comes into contact with a diamond wire; cutting: setting cutting parameters, and cutting the square rod by forward and reverse reciprocating movement along the diamond wire, wherein during cutting process, first speed of the working platform varies synchronously with wire speed; and unloading: unloading after the cutting step is finished, wherein the square rod is gradually separated from the diamond wire.

### CROSS REFERENCE TO RELATED APPLICATIONS

The present disclosure claims the benefit of priority to Chinese Patent Application No. 202211279194.4 filed on Oct. 19, 2022, the content of which is incorporated herein by reference in its entirety.

### TECHNICAL FIELD

The present disclosure relates to solar silicon wafer processing, and particularly relates to methods for cutting a monocrystalline silicon square rod.

### BACKGROUND

In a process for cutting into solar silicon wafers, the silicon wafers with a line mark is always not expected in the process. The silicon wafers with the line mark account for 1˜20% of defectively cut silicon wafers. In recent years, with rapid development of photovoltaic power generation and semiconductor industry, higher requirements have put forward for the processing of the silicon wafers. On one hand, to reduce manufacture cost, the silicon wafers are required to have larger diameters. On the other hand, the silicon wafers are required to have higher flatness accuracy and smaller surface roughness (the surface quality of the silicon wafer can effectively improve photoelectric conversion efficiency). Processing difficulty for the silicon wafers is greatly increased due to these requirements.

As price of raw materials for photovoltaic native polysilicon increases, market competition of the silicon wafers is stimulated. In order to improve quality and increase the number of the silicon wafers per kilogram, parameters in the cutting process are controlled, yield is improved, and occurrence of abnormal products is reduced.

Currently, for G12-sized silicon wafers, the line mark is a relatively important factor affecting the surface quality of the silicon wafers. There are deep and shallow line marks on surfaces of the silicon wafers. The cutting ability is insufficient when the diamond wire is used to perform the cutting, which causes the line marks on the silicon wafers. Reducing the surface roughness and the line marks of the silicon wafers needs to be solved urgently.

### SUMMARY

In view of the above, a method for cutting a monocrystalline silicon square rod is provided. The method includes the steps of: loading: providing a square rod on a working platform and clamping the square rod, and lowering the square rod until it comes into contact with a diamond wire; cutting: setting cutting parameters, and cutting the square rod by forward and reverse reciprocating movement of the diamond wire along an extension direction of the diamond wire, wherein in the cutting step, platform speed varies synchronously with wire speed; and unloading: gradually separating the square rod from the diamond wire.

In some embodiment of the present disclosure, the cutting step includes a tool-feeding step, a main-cutting step, and a tool-retracting step, wherein throughout the tool-feeding step, the main-cutting step, and the tool-retracting step, the first speed varies synchronously with the wire speed.

In some embodiment of the present disclosure, in the tool-feeding step, the diamond wire contact and cut the square rod, until a cutting depth for the square rod reaches 5% of a height of the square rod, when the diamond wire is moved in a forward direction in the tool-feeding process, the wire speed is increased from 0 m/min to a feeding wire speed set value at a constant rate, and then decreased from the feeding wire speed set value to 0 m/min at a constant rate, to change a movement direction of the diamond wire, and when the diamond wire is moved in a reverse direction, the working platform repeats the above movement, and the wire speed varies in the same way as that in the forward direction.

In some embodiment of the present disclosure, the first speed of the working platform varies synchronously with the wire speed in the tool-feeding step in positive correlation, when the diamond wire is moved in the forward direction, a propulsion speed of the working platform is increased from 0.2 mm/min to a feeding first speed set value at a constant rate, and then decreased from the feeding first speed set value to 0.2 mm/min at a constant rate, and when the diamond wire is moved in the reverse direction, the working platform repeats the above movement, and the first speed varies in the same way as that in the forward direction.

In some embodiment of the present disclosure, the feeding wire speed set value is set in a range of 600 m/min to 1500 m/min, the feeding first speed set value is set in a range of 0.4 mm/min to 1.2 mm/min, and each of acceleration time and deceleration time for the wire speed of the diamond wire is 5 seconds.

In some embodiment of the present disclosure, in the main-cutting step, a cutting depth reach 5%-60% of the height of the square rod, when the diamond wire is moved in a forward direction in the main-cutting process, the wire speed is increased from 0 m/min to a main-cutting wire speed set value at a constant rate, the diamond wire moves at a constant speed of the main-cutting wire speed set value, the wire speed is decreased from the main-cutting wire speed set value to 0 m/min at a constant rate, to change a movement direction of the diamond wire, and when the diamond wire is moved in a reverse direction, the wire speed repeats that in the forward direction.

In some embodiment of the present disclosure, the first speed of the working platform varies synchronously with the wire speed in the main-cutting process in positive correlation, when the diamond wire is moved in a forward direction in the main-cutting process, a propulsion speed of the working platform is increased from 0.2 mm/min to a main-cutting first speed set value at a constant rate, and then the working platform moves at a constant speed of the main-cutting first speed set value while the diamond wire moves at the constant speed, the propulsion speed of the working platform is decreased from the main-cutting first speed set value to 0.2 mm/min at a constant rate, and when the diamond wire is moved in a reverse direction, the first speed varies in the same way as that in the forward direction.

In some embodiment of the present disclosure, the main-cutting wire speed set value is set in a range of 2100 m/min to 2400 m/min, the main-cutting first speed set value is set in a range of 2.2 mm/min to 3.2 mm/min, and each of acceleration time and deceleration time for the wire speed of the diamond wire both is 5 seconds.

In some embodiment of the present disclosure, in the tool-retracting step, a cutting depth reach 60%-100% of the height of the square rod, when the diamond wire is moved in a forward direction in the tool-retracting process, the wire speed is increased from 0 m/min to a tool-retracting wire speed set value at a constant rate, the diamond wire moves at a constant speed of the tool-retracting wire speed set value, the wire speed is decreased from the tool-retracting wire speed set value to 0 m/min at a constant rate, to change a movement direction of the diamond wire, and when the diamond wire is moved in a reverse direction, the wire speed varies in the same way as that in the forward direction.

In some embodiment of the present disclosure, the first speed of the working platform varies synchronously with the wire speed in the tool-retracting process in positive correlation, when the diamond wire is moved in a forward direction in the tool-retracting process, a propulsion speed of the working platform is increased from 0.2 mm/min to a tool-retracting first speed set value at a constant rate, and then the working platform moves at a constant speed of the tool-retracting first speed set value while the diamond wire moves at the constant speed, the propulsion speed of the working platform is decreased from the tool-retracting first speed set value to 0.2 mm/min at a constant rate, and when the diamond wire is moved in a reverse direction, the first speed varies in the same way as that in the forward direction.

In some embodiment of the present disclosure, the tool-retracting wire speed set value is set in a range of 2100 m/min to 2400 m/min, the tool-retracting first speed set value is set in a range of 0.3 mm/min to 3.2 mm/min, and each of acceleration time and deceleration time for the diamond wire is 5 seconds.

### BRIEF DESCRIPTION OF THE DRAWING

FIG. 1 is a schematic flowchart of a method for cutting a monocrystalline silicon square rod according to an embodiment of the present disclosure.

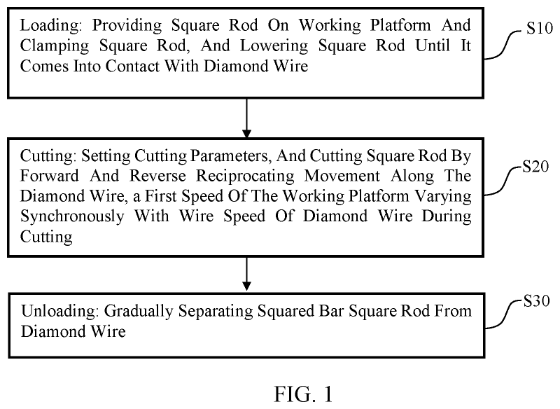

### DETAILED DESCRIPTION

The present disclosure will be further described with reference to the following embodiments and the accompanying drawing.

In an embodiment of the present disclosure, a method for cutting a monocrystalline silicon square rod includes the following steps.

At step S10: Loading: providing a square rod on a working platform and clamping the square rod, and lowering the square rod until it comes into contact with a diamond wire.

In particular, after a rod is squared to obtain the square rod, the square rod is fixed to the working platform of a slicer, and the square rod is lowered until the square rod is into contact with the diamond wire. Therefore, the loading preparation is completed.

At step S20: Cutting: setting cutting parameters, and cutting the square rod by forward and reverse reciprocating movement of the diamond wire along an extension direction of the diamond wire. During the cutting process, platform speed (or first speed) varies synchronously with wire speed of the diamond wire. The platform speed may be a propulsion speed of the working platform, that is, a speed at which the square rod presses down the diamond wire. The wire speed may be cutting speed of the diamond wire. In a current slicing process, a diamond wire is mainly used, and the platform speed does not vary with the cutting speed of the diamond wire during the cutting process. In this case, the line mark is generated on the silicon wafer at the moment the diamond wire pauses in a commutation operation, and a rate of the silicon wafers with the line mark to all of the cut silicon wafers is largest. In an embodiment of the present disclosure, the platform speed and the wire speed in the cutting process are improved, so that the platform speed may vary synchronously with the wire speed. By synchronizing the platform speed and the wire speed, a spacing between the line textures may be shortened, and occurrence of the line textures may be reduced, thereby preventing occurrence of the line mark and the roughness of the silicon wafer. Specifically, the cutting step includes the following substeps.

At substep S21: Tool-feeding: making the diamond wire contact and cut the square rod, until a cutting depth for the square rod reaches 5% of a height of the square rod, and synchronizing the platform speed with the wire speed. In particular, the diamond wire is continuously released and retracted in a tool-feeding process, that is, performs the commutation operation of forward and reverse reciprocating movement of the diamond wire along the diamond wire. When the diamond wire is moved in a forward direction in the tool-feeding process, the wire speed is increased from 0 m/min to a feeding wire speed set value at a constant rate, and then decreased from the feeding wire speed set value to 0 m/min at a constant rate, so as to so as to change a movement direction of the diamond wire. When the diamond wire is moved in a reverse direction, the working platform repeats the above movement, and the wire speed varies in the same way as that in the forward direction. Acceleration time and deceleration time for the wire speed of the diamond wire both may be 5 seconds.

The platform speed of the working platform varies synchronously with the wire speed in the tool-feeding process in positive correlation. Because it is necessary to start the table to approach the diamond wire, the working platform has an initial speed of in the tool-feeding process. That is, when the diamond wire is moved in a forward direction, the propulsion speed of the working platform is increased from 0.2 mm/min to a feeding platform speed set value at a constant rate, and then decreased from the feeding platform speed set value to 0.2 mm/min at a constant rate. When the diamond wire is moved in a reverse direction, the working platform repeats the above movement, and the platform speed varies in the same way as that in the forward direction. By synchronously correlating the propulsion speed of the working platform with the wire speed of the diamond wire, the line mark generated on the silicon wafer during the period of pause in the commutation operation is prevented or reduced. In this case, the feeding wire speed set value may be set in a range of 600 m/min to 1500 m/min, for example, 600 m/min, 700 m/min, 800 m/min, 900 m/min, 1000 m/min, 1100 m/min, 1200 m/min, 1300 m/min, 1400 m/min, or 1500 m/min. The feeding platform speed set value is set in a range of 0.4 mm/min to 1.2 mm/min, for example, 0.4 mm/min, 0.5 mm/min, 0.6 mm/min, 0.7 mm/min. 0.8 mm/min, 0.9 mm/min, 1.0 mm/min, 1.1 mm/min, or 1.2 mm/min.

At substep S22: Main-cutting: making the cutting depth reach 5% to 60% of the height of the square rod, and keeping the platform speed and the wire speed in synchronism. In particular, the diamond wire is also continuously released and retracted in the main-cutting process. The diamond wire performs the commutation operation of forward and reverse reciprocating movement of the diamond wire along the diamond wire in the main-cutting process. When the diamond wire is moved in a forward direction in the main-cutting process, the wire speed is increased from 0 m/min to a main-cutting wire speed set value at a constant rate. The diamond wire moves at a constant speed of the main-cutting wire speed set value. Then, the wire speed is decreased from the main-cutting wire speed set value to 0 m/min at a constant rate, so as to change a movement direction of the diamond wire. When the diamond wire is moved in a reverse direction, the wire speed repeats the above process. The wire speed varies in the same way as that in the forward direction. Acceleration time and deceleration time for the wire speed of the diamond wire both may be 5 seconds.

The platform speed of the working platform varies synchronously with the wire speed in the main-cutting process in positive correlation. That is, when the diamond wire is moved in a forward direction in the main-cutting process, the propulsion speed of the working platform is increased from 0.2 mm/min to a main-cutting platform speed set value at a constant rate, and then the working platform moves at a constant speed of the main-cutting platform speed set value while the diamond wire moves at the constant speed. Then, the propulsion speed of the working platform is decreased from the main-cutting platform speed set value to 0.2 mm/min at a constant rate. When the diamond wire is moved in a reverse direction, the working platform repeats the above movement, and the platform speed varies in the same way as that in the forward direction. By synchronously correlating the propulsion speed of the working platform with the wire speed of the diamond wire, the line mark generated on the silicon wafer during the period of pause in the commutation operation is prevented or reduced. The main-cutting wire speed set value may be set in a range of 2100 m/min to 2400 m/min, for example, 2100 m/min, 2200 m/min, 2300 m/min, or 2400 m/min. The main-cutting platform speed set value is set in a range of 2.2 mm/min to 3.2 mm/min, for example, 2.2 mm/min, 2.3 mm/min, 2.4 mm/min, 2.5 mm/min, 2.6 mm/min, 2.7 mm/min, 2.8 mm/min, 2.9 mm/min, 3.0 mm/min, 3.1 mm/min, or 3.2 mm/min.

At substep S23: Tool-retracting: making the cutting depth reach 60% to 100% of the height of the square rod, and keeping the platform speed and the wire speed in synchronism. In particular, the diamond wire performs the commutation operation of forward and reverse reciprocating movement of the diamond wire along the diamond wire in the tool-retracting process. When the diamond wire is moved in a forward direction in the tool-retracting process, the wire speed is increased from 0 m/min to a tool-retracting wire speed set value at a constant rate. The diamond wire moves at a constant speed of the tool-retracting wire speed set value. Then, the wire speed is decreased from the tool-retracting wire speed set value to 0 m/min at a constant rate, so as to change a movement direction of the diamond wire. When the diamond wire is moved in a reverse direction, the wire speed repeats the above process. The wire speed varies in the same way as that in the forward direction. Throughout the tool-retracting process, acceleration time and deceleration time for the diamond wire both may be 5 seconds.

The platform speed of the working platform varies synchronously with the wire speed in the tool-retracting process in positive correlation. That is, when the diamond wire is moved in a forward direction in the tool-retracting process, the propulsion speed of the working platform is increased from 0.2 mm/min to a tool-retracting platform speed set value at a constant rate, and then the working platform moves at a constant speed of the tool-retracting platform speed set value while the diamond wire moves at the constant speed. Then, the propulsion speed of the working platform is decreased from the tool-retracting platform speed set value to 0.2 mm/min at a constant rate. When the diamond wire is moved in a reverse direction, the working platform repeats the above movement, and the platform speed varies in the same way as that in the forward direction. By synchronously correlating the propulsion speed of the working platform with the wire speed of the diamond wire, the line mark generated on the silicon wafer during the period of pause in the commutation operation is prevented or reduced. The tool-retracting wire speed set value may be set in a range of 2100 m/min to 2400 m/min, for example, 2100 m/min, 2200 m/min, 2300 m/min, or 2400 m/min. The tool-retracting platform speed set value may be set in a range of 0.3 mm/min to 3.2 mm/min, for example, 0.3 mm/min, 0.4 mm/min, 0.5 mm/min, 0.6 mm/min, 0.7 mm/min, 0.8 mm/min, 0.9 mm/min, 1.0 mm/min, 1.1 mm/min, 1.2 mm/min, 1.3 mm/min, 1.4 mm/min, 1.5 mm/min, 1.6 mm/min, 1.7 mm/min, 1.8 mm/min, 1.9 mm/min, 2.0 mm/min, 2.1 mm/min, 2.2 mm/min, 2.3 mm/min, 2.4 mm/min, 2.5 mm/min, 2.6 mm/min, 2.7 mm/min, 2.8 mm/min, 2.9 mm/min, 3.0 mm/min, 3.1 mm/min, or 3.2 mm/min.

At step S30: Unloading: during the cutting process, cutting the monocrystalline silicon square rod on the working platform into the silicon wafers by a downward movement of the working platform, together with a reciprocating movement of the diamond wire between an upper bobbin and a lower bobbin. The unloading step is performed, after the cutting step is finished. The square rod is gradually separated from the diamond wire. The silicon wafers are removed from the working platform of the slicer, and the silicon wafers are checked for subsequent operation steps.

In order to prevent the waste of the diamond wire caused by an abnormal wire mesh after the cutting step, the reciprocal cutting process is adopted, and the difference value of a return wire (a difference between a forward travel distance and a backward travel distance of the diamond wire) after the simulation of the cutting process is 0 to 5000 m. By synchronizing the platform speed with the wire speed, the platform speed varies synchronously with the wire speed while the wire speed varies, and the above process continues until the silicon wafers are obtained. In the process for cutting into silicon wafers, the line mark may be improved by the correlation between the platform speed and the wire speed, and the line mark may be improved by synchronizing the platform speed with the wire speed in the tool-feeding process, thereby changing poor parameters of the silicon wafer, and effectively reducing a width and a depth of the line texture.

### Embodiment 1

A method for cutting a monocrystalline silicon square rod includes the steps of:
Step S10: Loading: providing a square rod on a working platform and clamping the square rod, and lowering the square rod until it comes into contact with a diamond wire.
Step S20: Cutting: setting cutting parameters, and cutting the square rod by forward and reverse reciprocating movement of the diamond wire along an extension direction of the diamond wire. The cutting step includes the steps of:
Substep S21: Tool-feeding: making the diamond wire contact and cut the square rod, until a cutting depth for the square rod reaches 5% of a height of the square rod. In particular, the diamond wire performs the commutation operation of forward and reverse reciprocating movement along the diamond wire. When the diamond wire is moved in a forward direction in the tool-feeding process, the wire speed is increased from 0 m/min to 800 m/min at a constant rate, and then decreased from 800 m/min to 0 m/min at a constant rate, so as to so as to change a movement direction of the diamond wire. When the diamond wire is moved in a reverse direction, the wire speed varies in the same way as that in the forward direction. Acceleration time and deceleration time for the wire speed of the diamond wire both may be 5 seconds.

The platform speed of the working platform varies synchronously with the wire speed in the tool-feeding process in positive correlation. When the diamond wire is moved in a forward direction, the propulsion speed of the working platform is increased from 0.2 mm/min to 0.8 mm/min at a constant rate, and then decreased from 0.8 mm/min to 0.2 mm/min at a constant rate. When the diamond wire is moved in a reverse direction, the working platform repeats the above movement, and the platform speed varies in the same way as that in the forward direction.
Substep S22: Main-cutting: making the cutting depth reach 5%-60% of the height of the square rod. The diamond wire performs the commutation operation of forward and reverse reciprocating movement of the diamond wire along the diamond wire in the main-cutting process. When the diamond wire is moved in a forward direction in the main-cutting process, the wire speed is increased from 0 to 2200 m/min at a constant rate. The diamond wire moves at a constant speed of the main-cutting wire speed set value. Then, the wire speed is decreased from 2200 m/min to 0 m/min at a constant rate, so as to change a movement direction of the diamond wire. When the diamond wire is moved in a reverse direction, the wire speed repeats the above process. The wire speed varies in the same way as that in the forward direction. Acceleration time and deceleration time for the wire speed of the diamond wire both may be 5 seconds.

The platform speed of the working platform varies synchronously with the wire speed in the main-cutting process in positive correlation. When the diamond wire is moved in a forward direction in the main-cutting process, the propulsion speed of the working platform is increased from 0.2 mm/min to 2.4 mm/min at a constant rate, and then the working platform moves at a constant speed of 2.4 mm/min while the diamond wire moves at the constant speed. Then, the propulsion speed of the working platform is decreased from 2.4 mm/min to 0.2 mm/min at a constant rate. When the diamond wire is moved in a reverse direction, the working platform repeats the above movement, and the platform speed varies in the same way as that in the forward direction.
Substep S23: Tool-retracting: making the cutting depth reach 60%-100% of the height of the square rod. The diamond wire performs the commutation operation of forward and reverse reciprocating movement of the diamond wire along the diamond wire in the tool-retracting process. When the diamond wire is moved in a forward direction in the tool-retracting process, the wire speed is increased from 0 m/min to 2200 m/min at a constant rate. The diamond wire moves at a constant speed of 2200 m/min. Then, the wire speed is decreased from 2200 m/min to 0 m/min at a constant rate, so as to change a movement direction of the diamond wire. When the diamond wire is moved in a reverse direction, the wire speed repeats the above process. The wire speed varies in the same way as that in the forward direction. Throughout the tool-retracting process, acceleration time and deceleration time for the diamond wire both may be 5 seconds.

The platform speed of the working platform varies synchronously with the wire speed in the tool-retracting process in positive correlation. When the diamond wire is moved in a forward direction in the tool-retracting process, the propulsion speed of the working platform is increased from 0.2 mm/min to 1.5 mm/min at a constant rate, and then the working platform moves at a constant speed of 1.5 mm/min while the diamond wire moves at the constant speed. Then, the propulsion speed of the working platform is decreased from 1.5 mm/min to 0.2 mm/min at a constant rate. When the diamond wire is moved in a reverse direction, the working platform repeats the above movement, and the platform speed varies in the same way as that in the forward direction.
Step S30: Unloading: performing an unloading step after the cutting step is finished. The square rod is gradually separated from the diamond wire. The silicon wafers are removed from the working platform of the slicer, and the silicon wafers are checked for subsequent operation steps.

The platform speed and the wire speed in the cutting process are improved so that the platform speed varies synchronously with the wire speed. The platform speed varies synchronously with the wire speed while the wire speed varies, and the above process continues until the silicon wafers are obtained. By synchronizing the platform speed with the wire speed, or by reducing the propulsion speed of the working platform in the case of the lower wire speed in the commutation operation, the spacing between the line textures may be shortened, and occurrence of the line textures may be reduced, thereby effectively reducing a width and a depth of the line texture. Abrasion of the diamond wire to the silicon wafer when a movement direction of the diamond wire is changed may be reduced, thereby changing the poor parameters of the silicon wafer, and reducing the occurrence of the line marks and the roughness of the silicon wafer.

Some embodiments of the present disclosure have been described in detail above, but should not be considered as limiting the scope of the present disclosure. All equivalents and modifications made in accordance with the embodiments of the present disclosure shall fall within the scope of the present disclosure.

What is claimed is:

1. A method for cutting a monocrystalline silicon square rod, comprising steps of:
loading: providing the square rod on a working platform and clamping the square rod, and lowering the square rod until it comes into contact with a diamond wire;
cutting: setting cutting parameters, and cutting the square rod by forward and reverse reciprocating movement of the diamond wire along an extension direction of the diamond wire, a first speed of the working platform varying synchronously with wire speed of the diamond wire during the cutting; and
unloading: gradually separating the square rod from the diamond wire.

2. The method of claim 1, wherein the cutting step comprises a tool-feeding step, a main-cutting step, and a tool-retracting step, wherein throughout the tool-feeding step, the main-cutting step, and the tool-retracting step, the first speed varies synchronously with the wire speed.

3. The method of claim 2, wherein in the tool-feeding step, the diamond wire contact and cut the square rod, until a cutting depth for the square rod reaches 5% of a height of the square rod,
when the diamond wire is moved in a forward direction in the tool-feeding process, the wire speed is increased from 0 m/min to a feeding wire speed set value at a constant rate, and then decreased from the feeding wire speed set value to 0 m/min at a constant rate, to change a movement direction of the diamond wire, and
when the diamond wire is moved in a reverse direction, the working platform repeats the above movement, and the wire speed varies in the same way as that in the forward direction.

4. The method of claim 3, wherein the first speed of the working platform varies synchronously with the wire speed in the tool-feeding step in positive correlation,
when the diamond wire is moved in the forward direction, a propulsion speed of the working platform is increased from 0.2 mm/min to a feeding first speed set value at a constant rate, and then decreased from the feeding first speed set value to 0.2 mm/min at a constant rate, and
when the diamond wire is moved in the reverse direction, the working platform repeats the above movement, and the first speed varies in the same way as that in the forward direction.

5. The method of claim 4, wherein the feeding wire speed set value is set in a range of 600 m/min to 1500 m/min, the feeding first speed set value is set in a range of 0.4 mm/min to 1.2 mm/min, and each of acceleration time and deceleration time for the wire speed of the diamond wire is 5 seconds.

6. The method of claim 2, wherein in the main-cutting step, a cutting depth reach 5%-60% of the height of the square rod,
when the diamond wire is moved in a forward direction in the main-cutting process, the wire speed is increased from 0 m/min to a main-cutting wire speed set value at a constant rate, the diamond wire moves at a constant speed of the main-cutting wire speed set value, the wire speed is decreased from the main-cutting wire speed set value to 0 m/min at a constant rate, to change a movement direction of the diamond wire, and
when the diamond wire is moved in a reverse direction, the wire speed repeats that in the forward direction.

7. The method of claim 6, wherein the first speed of the working platform varies synchronously with the wire speed in the main-cutting process in positive correlation,
when the diamond wire is moved in a forward direction in the main-cutting process, a propulsion speed of the working platform is increased from 0.2 mm/min to a main-cutting first speed set value at a constant rate, and then the working platform moves at a constant speed of the main-cutting first speed set value while the diamond wire moves at the constant speed, the propulsion speed of the working platform is decreased from the main-cutting first speed set value to 0.2 mm/min at a constant rate, and
when the diamond wire is moved in a reverse direction, the first speed varies in the same way as that in the forward direction.

8. The method of claim 7, wherein the main-cutting wire speed set value is set in a range of 2100 m/min to 2400 m/min, the main-cutting first speed set value is set in a range of 2.2 mm/min to 3.2 mm/min, and each of acceleration time and deceleration time for the wire speed of the diamond wire both is 5 seconds.

9. The method of claim 2, wherein in the tool-retracting step, a cutting depth reach 60%-100% of the height of the square rod,
when the diamond wire is moved in a forward direction in the tool-retracting process, the wire speed is increased from 0 m/min to a tool-retracting wire speed set value at a constant rate, the diamond wire moves at a constant speed of the tool-retracting wire speed set value, the wire speed is decreased from the tool-retracting wire speed set value to 0 m/min at a constant rate, to change a movement direction of the diamond wire, and
when the diamond wire is moved in a reverse direction, the wire speed varies in the same way as that in the forward direction.

10. The method of claim 9, wherein the first speed of the working platform varies synchronously with the wire speed in the tool-retracting process in positive correlation,
when the diamond wire is moved in a forward direction in the tool-retracting process, a propulsion speed of the working platform is increased from 0.2 mm/min to a tool-retracting first speed set value at a constant rate, and then the working platform moves at a constant speed of the tool-retracting first speed set value while the diamond wire moves at the constant speed, the propulsion speed of the working platform is decreased from the tool-retracting first speed set value to 0.2 mm/min at a constant rate, and
when the diamond wire is moved in a reverse direction, the first speed varies in the same way as that in the forward direction.

11. The method of claim 10, wherein the tool-retracting wire speed set value is set in a range of 2100 m/min to 2400 m/min, the tool-retracting first speed set value is set in a range of 0.3 mm/min to 3.2 mm/min, and each of acceleration time and deceleration time for the diamond wire is 5 seconds.
